(19) United States
(12) Patent Application Publication
(10) Pub. No.: US 2023/0162503 A1
(43) Pub. Date: May 25, 2023

(54) MONITORING INFORMATION MANAGEMENT SYSTEM, MONITORING INFORMATION MANAGEMENT PROGRAM, AND MONITORING INFORMATION MANAGEMENT METHOD

(71) Applicant: Kaoru WATANABE, Koto-ku, Tokyo (JP)

(72) Inventor: Kaoru WATANABE, Koto-ku, Tokyo (JP)

(21) Appl. No.: 17/917,558

(22) PCT Filed: Mar. 12, 2021
(86) PCT No.: PCT/JP2021/010108

§ 371 Date: Oct. 7, 2022

(30) Foreign Application Priority Data
Apr. 13, 2020 (JP) 2020-071824

(51) Int. Cl. G06V 20/52; G06T 5/00; G06T 7/70; H04N 23/50

(52) U.S. Cl. CPC G06V 20/52; G06T 5/002; G06T 5/003; G06T 7/70; H04N 23/50

(57) ABSTRACT

To enhance protection of the privacy of a subject as well as reducing a burden on an observer by automatically detecting occurrence of an abnormality in a monitoring system and excluding a human from monitoring.

Included are an image capturing device information disclosure unit 312a that discloses position information of a surveillance camera 2 through a communication network NW, a recorded data accumulation unit 320c that accumulates recorded data captured by the surveillance camera 2 in association with the position information, an image monitoring unit 314d that recognizes a change in a person, an action, or an event appearing in the recorded data and that detects an abnormality appearing in the recorded data, a restoration history recording unit 314c that records a history of requesting or executing restoration processing as restoration history information together with information specifying an accessor who has requested or executed the restoration processing, and a disclosed information management unit 312 that discloses the restoration history information.

### TECHNICAL FIELD

The present invention relates to a monitoring information management system, a monitoring information management program, and a monitoring information management method for securing social safety while protecting the privacy of a subject using a camera disposed on a communication network.

### BACKGROUND ART

Conventionally, in a technical field of a monitoring system, an operation in which the monitoring system is connected to a network and in which monitoring is performed by a remote server is often conducted due to the spread of the Internet. Also, the occurrence of an accident or a crime can be recognized by analyzing a recorded image. For example, an unmanned surveillance camera is installed in a building, and a security staff of a security company or the like monitors an image of the surveillance camera at a remote place, which can contribute to crime prevention.

Conventional techniques for automation of surveillance cameras include an image processing apparatus, an image processing system, and a program (refer to Patent Literature 1). In the technique disclosed in Patent Literature 1, a focus region is set in an entire view image of a monitoring region, the image of the set focus region is analyzed by an image analysis means to detect a moving object, and a zoom camera of a camera unit is operated on the basis of the detection to capture the image of the moving object.

### PRIOR ART DOCUMENTS

### Patent Documents

Patent Document 1: JP 2010-233185 A

### SUMMARY OF THE INVENTION

### Problems to be Solved by the Invention

However, privacy is not protected in a captured image, and even if the automation of the surveillance camera advances, it cannot always be stated that a person who monitors the image is never malicious since the person is a human although the purpose is monitoring, and it cannot be denied that the image captured for the monitoring purpose may be used for wrong purposes. Also, even if the automation of the surveillance camera advances as described above, the final decision on an accident or a crime needs to be made by a person, and in such a case as well, whether the privacy of a subject is completely protected is not always guaranteed.

Under such circumstances, the present invention solves the above problems, and an object of the present invention is to provide a monitoring information management system, a monitoring information management program, and a monitoring information management method capable of further enhancing protection of the privacy of a subject as well as reducing a burden on an observer by automatically detecting occurrence of an abnormality in a monitoring system and excluding a human from monitoring.

### Means for Solving Problem

In order to solve the above problems, the present invention provides a monitoring information management system that performs monitoring by means of an image capturing device that captures an image or a moving image, including a position information acquisition unit that specifies a current position of the image capturing device, a position information acquisition unit that specifies a current position of the image capturing device, an image capturing device information disclosure unit that discloses position information of the image capturing device specified by the position information acquisition unit through a communication network, an image accumulation unit that accumulates an image or a moving image captured by the image capturing device as recorded data in association with the position information, and an image monitoring unit that recognizes a change in a person, an action, or an event appearing in the recorded data captured by the image capturing device and that detects an abnormality appearing in the recorded data.

Also, the present invention provides a monitoring information management method that performs monitoring by means of an image capturing device that captures an image or a moving image, including

(1) an image capturing device information disclosure step of specifying, by means of a position information acquisition unit, a current position of the image capturing device, and disclosing, by means of an image capturing device information disclosure unit, position information of the image capturing device specified by the position information acquisition unit through a communication network,

(2) an image capturing device information disclosure step of specifying, by means of a position information acquisition unit, a current position of the image capturing device, and disclosing, by means of an image capturing device information disclosure unit, position information of the image capturing device specified by the position information acquisition unit through a communication network, and

(3) an image monitoring step of accumulating an image or a moving image captured by the image capturing device in an image accumulation unit as recorded data in association with the position information, and recognizing, by means of an image monitoring unit, a change in a person, an action, or an event appearing in the recorded data captured by the image capturing device and detecting an abnormality appearing in the recorded data.

In the above-described aspect of the invention, the method preferably includes an edit processing unit that makes a subject appearing in an image or a moving image captured by the image capturing device invisible and blurred, an edit processing unit that makes a subject appearing in an image or a moving image captured by the image capturing device invisible and blurred, a recorded data accumulation unit that accumulates the image or the moving image blurred by the edit processing unit as recorded data, a restoration processing unit that performs restoration processing of deblurring, in a step-by-step manner, a blurred portion in the recorded data accumulated in the recorded data accumulation unit, a restoration history recording unit that records a history of requesting or executing the restoration processing performed by the restoration processing unit as restoration history information together with information specifying an accessor who has requested or executed the restoration processing, and a restoration history information disclosure unit that discloses the restoration history information recorded by the restoration history recording unit through the communication network.

Note that the system and the method according to the present invention described above can be achieved by executing on a computer a program according to the present invention described in a predetermined language. That is, a monitoring information management program according to the present invention is a monitoring information management program that performs monitoring by means of an image capturing device that captures an image or a moving image, causing an information processing terminal to function as a position information acquisition unit that specifies a current position of the image capturing device, a position information acquisition unit that specifies a current position of the image capturing device, an image capturing device information disclosure unit that discloses position information of the image capturing device specified by the position information acquisition unit through a communication network, an image accumulation unit that accumulates an image or a moving image captured by the image capturing device as recorded data in association with the position information, and an image monitoring unit that recognizes a change in a person, an action, or an event appearing in the recorded data captured by the image capturing device and that detects an abnormality appearing in the recorded data.

In the above-described aspect of the invention, the program preferably causes the information processing terminal to further function as an edit processing unit that makes a subject appearing in an image or a moving image captured by the image capturing device invisible and blurred, a recorded data accumulation unit that accumulates the image or the moving image blurred by the edit processing unit as recorded data, a restoration processing unit that performs restoration processing of deblurring, in a step-by-step manner, a blurred portion in the recorded data accumulated in the recorded data accumulation unit, a restoration history recording unit that records a history of requesting or executing the restoration processing performed by the restoration processing unit as restoration history information together with information specifying an accessor who has requested or executed the restoration processing, and a restoration history information disclosure unit that discloses the restoration history information recorded by the restoration history recording unit through the communication network.

By installing the program according to the present invention in an IC chip or a memory device of a portable terminal device, a smartphone, a wearable terminal, a tablet PC, another information processing terminal, or a general-purpose computer such as a personal computer and a server computer, and executing the program on a CPU, the system having the above-described functions can be constructed, and the method according to the present invention can be implemented.

In the monitoring information management system, the program, and the method according to the present invention described above, an image capturing device according to the present invention is most preferably used as the image capturing device that performs monitoring. That is, the present invention provides an image capturing device that includes a function of transmitting a captured image through a communication means, including

a camera housing that has a spherical portion at least on a bottom surface thereof,

a support base that has a support surface including a spherical surface having a curvature matching that of the spherical portion of the bottom surface of the camera housing and that detachably supports the camera housing via the support surface,

a power reception coil that is disposed so as to face the spherical portion inside the camera housing, and

a power transmission coil that is disposed so as to face the support surface inside the support base and that can charge the power reception coil in a non-contact manner.

In the above-described aspect of the invention, the device preferably further includes attracting means that are provided respectively on the spherical portion side of the bottom surface of the camera housing and on the support surface side of the support base and that attract each other by means of magnetic forces. Also, in the above-described aspect of the invention, the support base preferably further includes a power supply means that supplies power to the power transmission coil, and a suspension means that suspends the camera housing supported via the support surface.

### Effects of the Invention

As described above, according to the above invention, for an image or a moving image captured by the image capturing device, the image monitoring unit including a technology such as artificial intelligence (AI) automatically recognizes a change in a person, an action, or an event appearing in recorded data captured by the image capturing device and detects an abnormality appearing in the recorded data. Therefore, it is possible to prevent a human from viewing the monitored image. Also, since the installation place of the image capturing device is disclosed on a map through a communication network, the fact that the place is a monitoring target can be disclosed in advance, which can be a deterrent for preventing a crime before it occurs. As a result, by excluding a human from monitoring, it is possible to further enhance protection of the privacy of a subject as well as reducing a burden on an observer.

Also, by performing mosaic processing in which a subject appearing in an image or a moving image captured by the image capturing device is blurred so as to be invisible, a state of preventing a human from viewing the monitored image can be achieved more reliably, and protection of privacy of the subject can further be enhanced.

In particular, restoration processing of deblurring, in a step-by-step manner, a blurred portion can be performed on the blurred recorded data, a protocol (procedure) of removing a mosaic as needed can be set as a system of the priority order of image blurring and the release authority. By doing so, a system of authorization in a range from a state where a human cannot view a monitored image to a state where the human can view the image can be provided, and so-called privacy control can be achieved.

For example, the aforementioned privacy control enables information specifying an individual in a monitored image to be acquired only in a step-by-step manner in the following order.

1) Mosaic on all

2) Mosaic on all except faces

3) Mosaic on place and things

4) Mosaic on persons

5) Mosaic on faces

Hence, for example, by enabling blurring of the persons and the place to be released in a step-by-step manner, the monitored image can effectively be used while the privacy of the persons captured is protected as in a case where only the behaviors of the persons can be checked without clarifying the place, in a case where, by clarifying the place and enabling the detailed behaviors of the persons to be visually recognized, the persons do not need to be specified, but the state of an accident or an incident having occurred at the place needs to be checked to some extent, or in another case, which is effective in preventing a crime and solving an incident.

Also, by setting an access protocol (procedure) in terms of information security as a system of managing access authority for releasing blurring, so-called access control can be implemented. As for the strength of the access authority, authority levels that can be released in a step-by-step manner are set as in the following example.

1) Court order of disclosure

2) Warrant of investigative organization

3) Security officer

4) General manager or the like

5) Manager or the like

6) Chief/store manager or the like

7) Regular employee

8) Other authorized staff

In a case where a person exercises the access authority and executes the privacy control to perform deblurring processing on the recorded data, information about the person who has executed the deblurring processing is disclosed to an unspecified large number of general viewers through a communication network. Thus, the general public can constantly check through the communication network that the privacy in the image captured by the surveillance camera is not violated, and it is possible to prevent the installer of the camera from viewing the monitored image for the purpose of abuse.

Furthermore, with the image capturing device according to the present invention described above, the camera housing is detachably supported on the support base by the magnetic force via the support surface, and the power reception coil is charged in a non-contact manner via the power transmission coil. Therefore, installation and operation of the camera are facilitated, and the degree of freedom of the installation place can be improved.

### BRIEF DESCRIPTION OF THE DRAWINGS

FIG. 1 is a conceptual diagram illustrating an overall configuration of a monitoring information management system according to an embodiment.

FIG. 2 is a block diagram illustrating an internal configuration of a camera constituting the monitoring information management system according to the embodiment.

FIG. 3 is a block diagram illustrating an internal configuration of a wireless base station constituting the monitoring information management system according to the embodiment.

FIG. 4 is a block diagram illustrating an internal configuration of an observer terminal device constituting the monitoring information management system according to the embodiment.

FIG. 5 is a block diagram illustrating an internal configuration of a monitoring information management server constituting the monitoring information management system according to the embodiment.

FIG. 6 is a flowchart illustrating an operation when a surveillance camera is installed in the monitoring information management system according to the embodiment.

FIG. 7 is a flowchart illustrating a monitoring operation performed by the surveillance camera in the monitoring information management system according to the embodiment.

FIG. 8 is a flowchart illustrating an operation at the time of abnormality detection performed by the surveillance camera in the monitoring information management system according to the embodiment.

FIG. 9 is a flowchart illustrating an operation at the time of information disclosure regarding the surveillance camera.

FIG. 10 is an explanatory diagram illustrating image processing according to the embodiment.

FIGS. 11A to 11C are explanatory diagrams illustrating image processing according to the embodiment.

FIGS. 12A and 12B are explanatory diagrams illustrating image processing according to the embodiment.

FIGS. 13A and 13B are perspective views illustrating an entire configuration of the surveillance camera according to the embodiment, in which FIG. 13A illustrates a large-diameter camera housing, and FIG. 13B illustrates a small-diameter camera housing.

FIG. 14 is a perspective view illustrating a use state of the surveillance camera according to the embodiment.

FIG. 15 is a perspective view illustrating a support base of the surveillance camera according to the embodiment.

FIG. 16 is an explanatory diagram illustrating an internal configuration of the support base according to the embodiment.

FIG. 17 is a block diagram conceptually illustrating a mechanism of wireless charging according to the embodiment.

FIGS. 18A and 18B are perspective views illustrating the surveillance camera according to a modification example of the embodiment.

### MODE FOR CARRYING OUT THE INVENTION

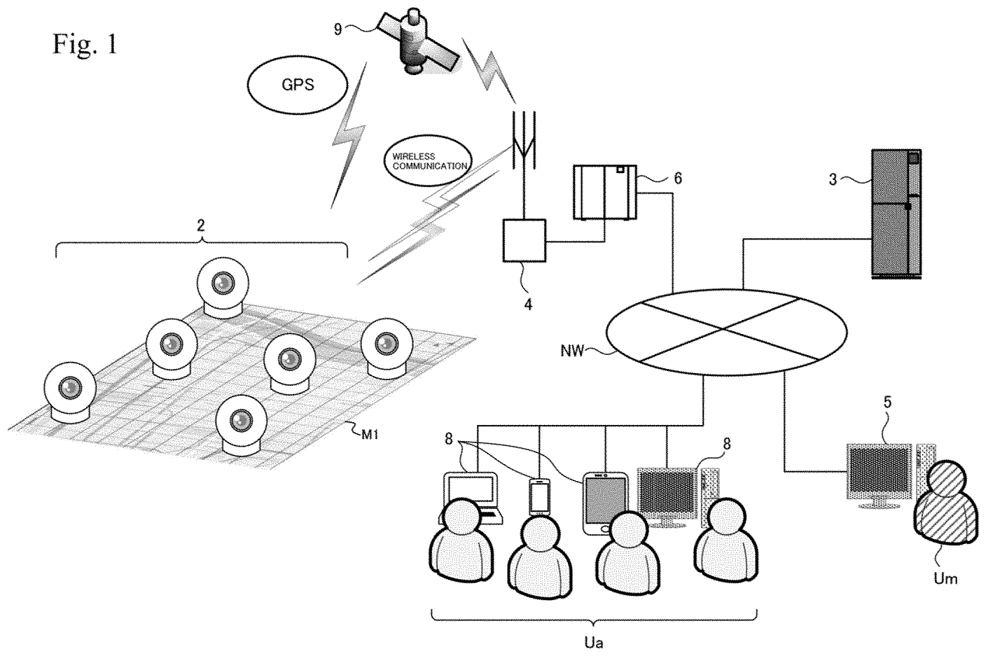

Hereinbelow, an embodiment of a monitoring information management system according to the present invention will be described in detail with reference to the accompanying drawings. FIG. 1 is a conceptual diagram illustrating an overall configuration of a monitoring information management system according to the present embodiment. Note that the embodiment described below exemplifies a device and the like for embodying the technical idea of the present invention, and the technical idea of the present invention does not limit the material, shape, structure, arrangement, and the like of each component to those described below. Various modifications can be made to the technical idea of the present invention within the scope of the claims.

(Overview of Monitoring Information Management Service)

A monitoring information management service according to the present embodiment is a service that monitors a predetermined place using an image, a picture, a sound, or other sensor detection data and provides accumulation, analysis, and management of each piece of recorded data (including a picture, a sound, or other sensor detection data) used for monitoring. Note that, in the present embodiment, the case where an owner of the monitoring device is also an installer who installs the monitoring device and where the installer is also an observer will be described as an example. However, the owner, the installer, the administrator, and the observer of the monitoring device may be different parties, and in this case, it is preferable to separate the access authorities of the respective parties and distinguish them by unique IDs.

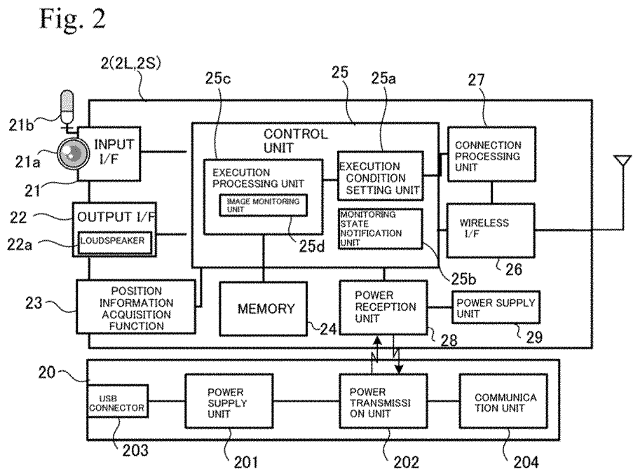

Mainly used as the recorded data for use in monitoring are an image or a moving image captured by a surveillance camera 2 as illustrated in FIG. 2, a sound recorded by a sound microphone, and detection data acquired from various sensors such as an infrared sensor, an illuminance sensor, a motion sensor, a temperature sensor, and an odor/smoke sensor. In the image or the moving image captured by the surveillance camera 2, due to a technology of artificial intelligence (AI) or the like included in image monitoring units 25d and 314d, a monitoring information management server 3 automatically recognizes a change in a person, an action, or an event appearing in the image to detect an abnormality in the image and performs mosaic processing in which a subject appearing in the captured image or moving image is blurred so as to be invisible to prevent a human from viewing the monitored image.

In particular, for the blurred recorded data, privacy control is implemented in which the mosaic of the blurred portion is removed in a step-by-step manner as necessary according to the conditions such as when, where, who, with whom, and what is being done, and access control is also implemented in which access authority to release blurring in a step-by-step manner is managed. Then, when some incident (case) such as an accident and an incident occurs, only in a case where the AI included in the image monitoring units 25d and 314d determines that it is necessary to confirm the image, a person having the access authority to release the mosaic can release the blurring in a step-by-step manner and visually confirm the image.

In addition, provided is a system in which the installation place of each of the surveillance cameras 2 is disclosed on a map through a communication network NW, in a case where the privacy control is executed by exercising the access authority to perform deblurring processing on the recorded data, information about the person who has executed the deblurring processing is disclosed to an unspecified large number of general viewers through the communication network, and the general public constantly checks through the communication network that the privacy in the images captured by the surveillance cameras is not violated.

The following cases are conceivable as applications and functions of the monitoring information management service.

(1) Additional Services for Hotels and Others

As additional services for a lodging facility such as a hotel and an inn, provided are functions of installing the surveillance cameras 2 in the entrance, various places in the building, and the guest rooms to detect suspicious persons and suspicious behavior and, in a case where an abnormality is detected, reporting, alerting, and causing a security guard to be dispatched. Also, by using face recognition and moving object detection by the AI included in the image monitoring units 25d and 314d, it is possible to provide a function of counting the number of people who go in and out of each room, a function of monitoring and reporting a visitor at the front or the like, a function of performing statistical analysis of a congestion state and reporting the result, a function of providing crime prevention and use statistics by deriving the male-to-female identification ratio, and a function of detecting an object that does not move for a certain period of time or a foreign object by the AI to detect an unattended suitcase or the like or a dangerous object.

(2) Additional Services for Restaurants and Others

As additional services for a store having a large number of guests, such as a restaurant, a store, and a shopping mall, provided are functions of installing the surveillance cameras 2 in various places in the store to detect suspicious persons and suspicious behavior and, in a case where an abnormality is detected, reporting, alerting, and causing a security guard to be dispatched. Also, by using face recognition and moving object detection by the AI included in the image monitoring units 25d and 314d, it is possible to provide a function of counting the number of people who go in and out of the store, a function of monitoring and reporting the register or the like, a function of performing statistical analysis of a congestion state and reporting the result, a function of providing crime prevention and use statistics by deriving the male-to-female identification ratio, and a function of detecting an object that does not move for a certain period of time or a foreign object by the AI to detect an unattended bag or the like or a dangerous object.

(3) Additional Services for Parking Lots

As additional services for a facility where a large number of vehicles enter and exit, such as a parking lot, provided are functions of installing the surveillance cameras 2 in various places in the parking lot to detect suspicious persons and suspicious behavior such as an accident, theft of a vehicle or a part (a wheel or the like), a car break-in, and mischief and, in a case where an abnormality is detected, reporting, alerting, and causing a security guard to be dispatched. Also, by using face recognition and moving object detection by the AI included in the image monitoring units 25d and 314d, it is possible to provide a function of counting the number of entering or exiting vehicles, a function of performing statistical analysis of a use status and reporting the result, and a function of providing sales prediction and sales statistics as well as cause analysis of an accident that has occurred on the premises.

(4) Additional Services for Warehouses and Factories

As additional services for a facility where a large number of articles are distributed and produced, such as a warehouse and a factory, provided are functions of installing the surveillance cameras 2 in various places on the premises to detect suspicious persons and suspicious behavior and, in a case where an abnormality is detected, reporting, alerting, and causing a security guard to be dispatched. Also, by using face recognition and moving object detection by the AI included in the image monitoring units 25d and 314d, it is possible to provide a function of counting the number of cart carriages operating on the premises, containers, and packages, the number of moving, entering, or exiting personnel, or the like, a function of performing statistical analysis of movement lines of packages or personnel and reporting the result, and a function of providing quality control by the AI.

(5) Additional Services for Agricultural Land

As additional services for a facility where production is performed with a large area and a small number of people, such as a farm, a ranch, and a plastic greenhouse, provided are functions of installing the surveillance cameras 2 in various places on the premises to detect suspicious persons and suspicious behavior and, in a case where an abnormality such as theft and damage by wildlife is detected, reporting, alerting, and causing a security guard to be dispatched. Also, by using face recognition and moving object detection by the AI included in the image monitoring units 25d and 314d, it is possible to provide a function of counting the number of persons or the like who go in and out of the premises, a function of performing statistical analysis of temperature, humidity, and luminance (illuminance) and reporting the result, a function of providing quality control by the AI, and a function of performing growth state statistical analysis.

(Entire Configuration of Monitoring Information Management System)

To fulfill the applications and functions described above, as illustrated in FIG. 1, the monitoring information management system according to the present embodiment is a system that performs monitoring by means of the surveillance cameras 2 that capture an image or a moving image. In the system, the surveillance cameras 2 having a function of performing data communication through the communication network NW including wireless communication are installed to face the monitoring targets located in various places, and the monitoring information management server 3 performs management and operation. Specifically, in the monitoring information management system according to the present embodiment, the monitoring information management server 3, a wireless base station 4, the surveillance camera 2 capable of performing wireless or wired communication through the wireless base station 4 or a communication satellite 9, and a terminal device 5 such as a general-purpose PC used by an observer are disposed on the communication network NW.

The communication network NW is the public telephone line network or the Internet communication network, and includes a wired line network and a wireless communication network. These line networks include a distributed communication network constructed by connecting various communication lines (public lines such as telephone lines, ISDN lines, ADSL lines, and optical lines, dedicated lines, and wireless communication networks such as 5G, 4G, LTE, and 3G) to each other using a communication protocol TCP/IP. Note that the communication network NW includes an intranet (intra-company network) such as 10BASE-T and 100BASE-TX, and a network in a predetermined area (a company, a household, or the like) such as a LAN and Wi-Fi.

The monitoring information management server 3 is an application server that is disposed on the communication network NW and remotely manages and controls each surveillance camera 2 by performing application management, device management, user management, operating state management, monitoring and control management, setting management, remote management, data collection management, and the like for each surveillance camera 2. With these management functions, the monitoring information management server 3 executes operation control on the surveillance camera 2 installed at a remote place, performs application setting on monitoring information management applications, gives a control notification in remote management, and collects data from the surveillance camera 2.

Specifically, the monitoring information management server 3 is a server device operated by a provider side of the monitoring information management service. In terms of the monitoring information management service, the server device registers identification information of an owner or an administrator (installer) of each surveillance camera and position information related to an installation place of the surveillance camera in advance, and executes a management service of each piece of monitoring information (recorded data and the like) on the basis of each piece of information transmitted from the surveillance camera 2.

A map M1 illustrated in FIG. 1 is installation position information in which position information on which the surveillance camera 2 is disposed is recorded as coordinates. The map M1 can be viewed by a general terminal 8 of a general viewer Ua through the communication network NW by means of a disclosed information distribution unit 303 as disclosed information. In the map M1, information regarding an installer Um who has installed the surveillance camera 2 and information regarding the release level are disclosed in association with position information such as coordinates and a place name in which the surveillance camera is disposed. In addition, image data at the release level according to the setting of the installer Um is also disclosed in association with the position information.

The wireless base station 4 is a device that is connected to the communication network NW through a relay device 6, establishes a wireless communication connection with the surveillance camera 2, and provides a call and data communication by means of the surveillance camera 2. Note that the wireless base station 4 in the present embodiment functions as a position information acquisition unit that manages in which cell each mobile terminal is located on the communication network NW. Specifically, the wireless base station 4 specifies the position of the surveillance camera 2 on the basis of a position registration request transmitted from the surveillance camera 2. In a case where the cell in which the mobile terminal is located is switched due to the movement of the user, this position registration request is transmitted from the surveillance camera 2 to a wireless base station that manages a cell in which the user is newly located, and the position of the surveillance camera 2 can be specified on the basis of the position registration request and base station identification information allocated to the femtocell base station.

The relay device 6 is a node device such as a modem, a terminal adapter, and a gateway device for connecting to the communication network NW, performs selection of a communication path and mutual conversion of data (signal), and performs relay processing between the wireless base station 4 and the communication network NW.

The terminal device 5 is an information processing terminal used by an observer or an owner/installer of the surveillance camera 2, has an arithmetic processing function by means of a CPU and a communication processing function by means of a communication interface, can be fulfilled by, for example, a general-purpose computer such as a personal computer or a dedicated device with specialized functions, and includes a smartphone, a mobile computer, a mobile phone, and the like.

(Structure of Each Device)

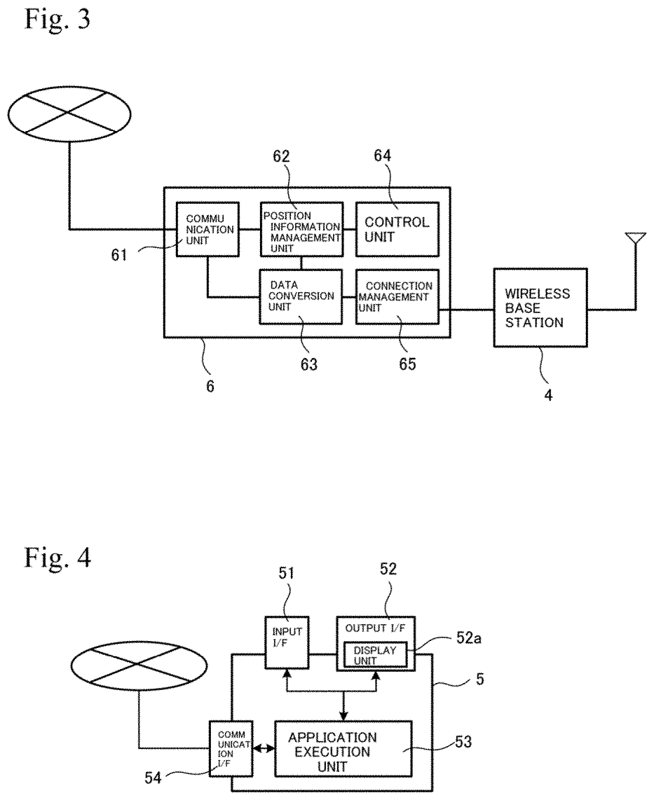

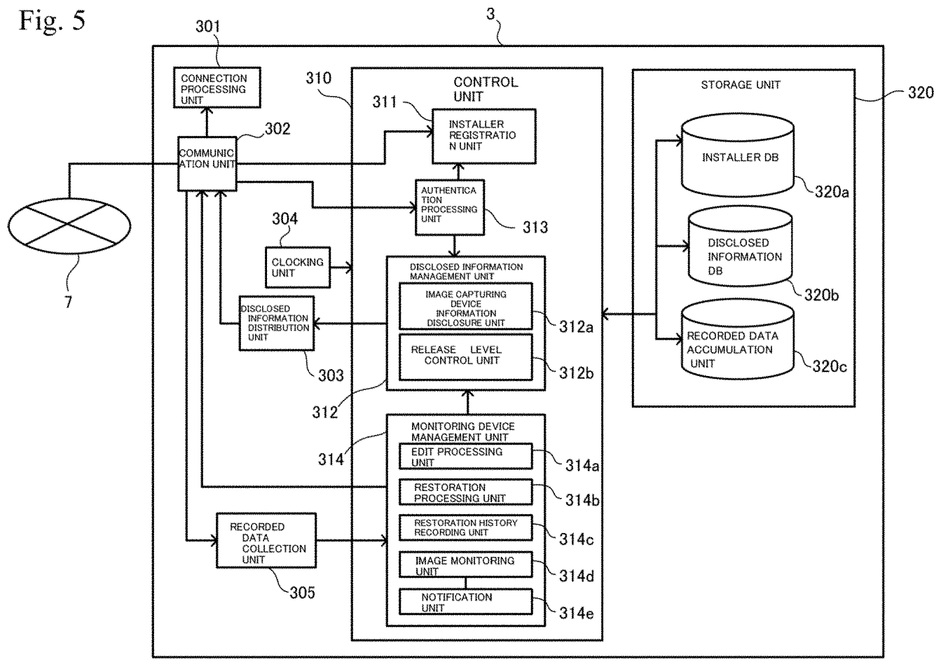

Next, a structure of each device constituting the aforementioned monitoring information management system will be described. FIG. 2 is a block diagram illustrating an internal configuration of the surveillance camera 2 constituting the monitoring information management system according to the present embodiment, FIG. 3 is a block diagram illustrating an internal configuration of the wireless base station 4 constituting the monitoring information management system according to the present embodiment, FIG. 4 is a block diagram illustrating an internal configuration of the terminal device 5 constituting the monitoring information management system according to the present embodiment, and FIG. 5 is a block diagram illustrating an internal configuration of the monitoring information management server 3 according to the present embodiment. Note that the “module” used in the description indicates a functional unit that includes hardware such as a system and a device, software having a function thereof, or a combination thereof, and achieves a predetermined operation.

(1) Surveillance Camera 2

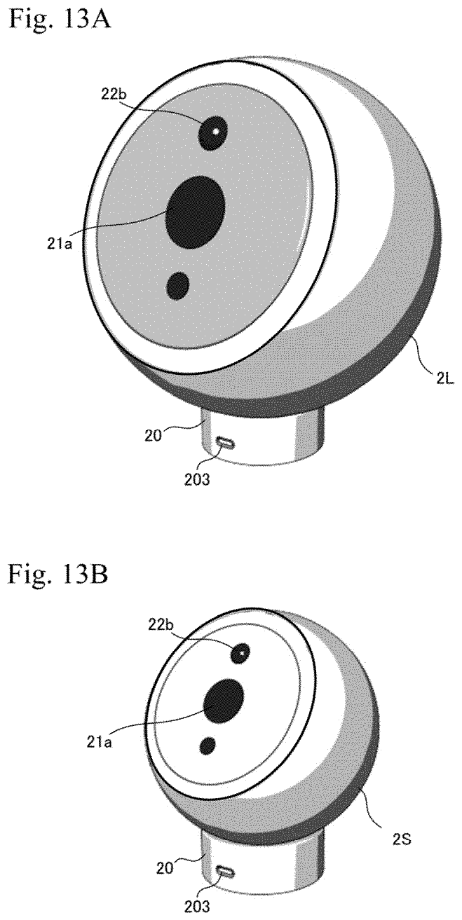

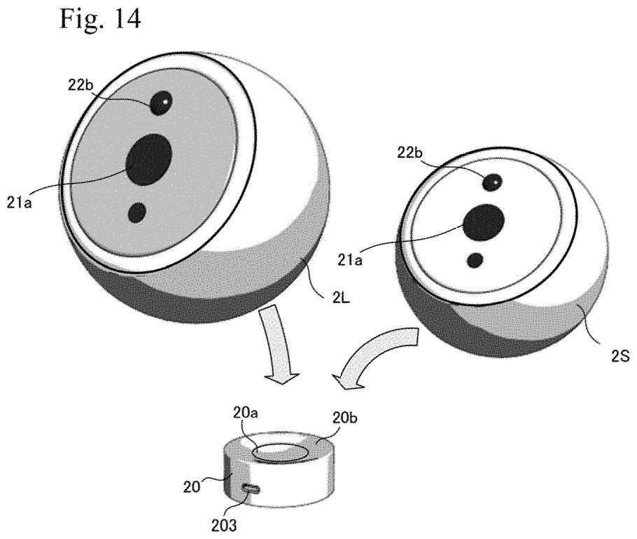

The surveillance camera 2 is an image capturing device having a function of optically capturing an image and a moving image, recording voice and a sound, transmitting a captured image through a communication means, and the like. Specifically, in the present embodiment, as illustrated in FIGS. 13A, 13B and 14, the surveillance camera 2 includes a camera housing 2L (or 2S) that serves as a main body having an image capturing function, and a support base 20 that detachably supports the camera housing.

In the present embodiment, as illustrated in FIGS. 13A and 13B, the camera housing 2L or 2S can be installed in two types having different diameters. The camera housing 2L or 2S is a casing having a spherical portion at least on a bottom surface thereof, and is provided on a front surface thereof with a planar and circular front panel, and a CCD camera 21a and an infrared light 22b are arranged on the front panel.

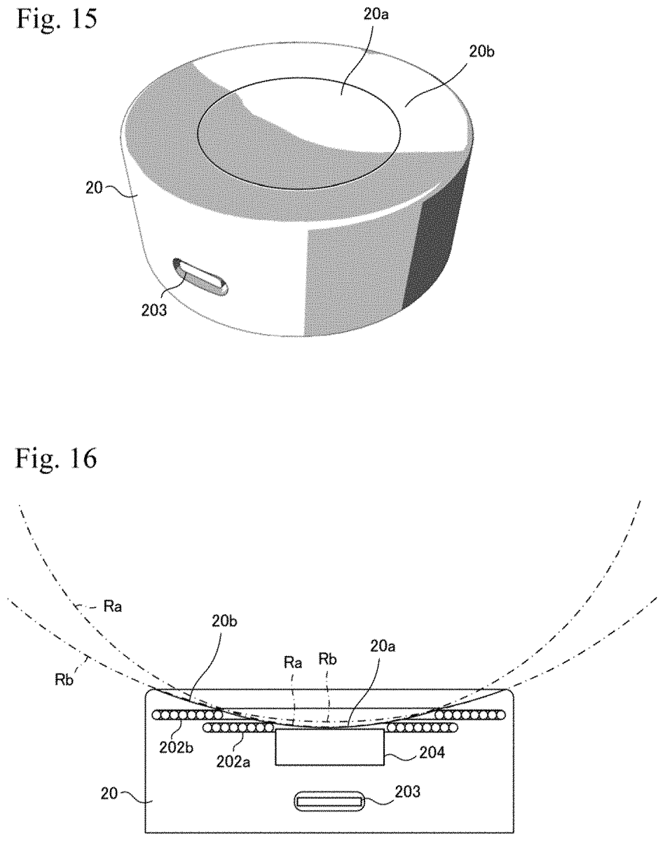

As illustrated in FIGS. 15 to 17, the support base 20 has on the upper portion thereof support surfaces 20a and 20b each including a spherical surface having a curvature matching that of the spherical portion of the bottom surface of the camera housing 2L (or 2S), and detachably supports the camera housing 2L (or 2S) via the support surface 20a or 20b.

Inside the support surfaces 20a and 20b of the support base 10, power transmission coils 202a and 202b are disposed so as to face the back surfaces of the support surfaces 20a and 20b and face upward. The power transmission coils 202a and 202b can charge a power reception coil 0 provided in the camera housing 2L (or 2S) in a non-contact manner. Also, at the center inside the support surfaces 20a and 20b of the support base 10, a magnet 204 is provided as an attracting means that attracts the camera housing 2L (or 2S) by means of a magnetic force.

Each of the support surfaces 20a and 20b is formed in a concave shape in which a curved surface (spherical surface) having a curvature matching the curvature of the bottom surface of the camera housing 2L (or 2S) mounted on the upper surface is formed. In the present embodiment, the support surface 20a is formed in a circular shape and is located at the center of the upper surface of the support base 10, and the support surface 20b is formed in a concentric shape located at the outer edge of the circular support surface 20a.

Also, as illustrated in FIG. 16, a curvature Ra of the support surface 20a at the center is larger than the curvature of the support surface 20b at the outer edge so that the camera housing 2S having a smaller diameter is matched with the support surface 20a at the center, and so that the camera housing 2L having a larger diameter is matched with the support surface 20b at the outer edge.

Also, the power transmission coils 202a and 202b are disposed so as to correspond to the support surfaces 20a and 2s0b, respectively. That is, the power transmission coils 202a and 202b are doughnut-shaped dielectric coils in each of which a conductive wire is formed in a spiral shape, the power transmission coil 202a having a smaller diameter is disposed at the center of the support base 20 in a planar view, and the power transmission coil 202b having a larger diameter is disposed above the power transmission coil 202a.

On the other hand, inside the lower end of the camera housing 2L (or 2S), the power reception coil 28d is disposed so as to face the spherical portion inside the camera housing 0, and a magnetic body that is attracted to the magnet 204 is provided on the spherical portion side of the bottom surface of the camera housing 2L (or 2S). With these configurations, both the camera housings 2L and 2S having different diameters can reliably be attracted and secured to the support base 20 and can receive power supply. In a state where the camera housing 2L or 2S is matched with the corresponding support surface 20b or 20a and is attracted and secured, the power transmission coil 202a or 202b is brought close in accordance with the diameter and curvature of the bottom surface of the matched camera housing, so that non-contact power supply can appropriately be performed.

Next, an internal configuration of the surveillance camera 2 will be described. As illustrated in FIG. 2, the surveillance camera 2 includes an input interface 21 and an output interface 22 as user interface modules. The input interface 21 is an interface to which are connected a device for inputting a user operation such as an operation button, the CCD camera 21a that captures an image and a moving image, a sound microphone 21b that acquires a sound, and various built-in or external sensors such as an infrared sensor, an illuminance sensor, a motion sensor, a temperature sensor, and an odor/smoke sensor. The output interface 22 is an interface to which a device that outputs an image or a sound, such as a display and a loudspeaker, is connected.

The surveillance camera 2 further includes a position information acquisition unit 23. The position information acquisition unit 23 is a module that measures the current position of the subject device. For example, the position information acquisition unit 23 can calculate coordinates of the current position on the basis of a GPS signal from the communication satellite 9, and acquire position information of the subject device on the network from a base station identifier of a base station which is a party of communication established by a connection processing unit 27 and a radio wave state such as signal intensity from the base station.

Also, the surveillance camera 2 includes a wireless interface 26 and the connection processing unit 27 as communication modules. The wireless interface 26 has a wireless communication function in conformity with a protocol for mobile communication for making a call and data communication, and a wireless communication function in conformity with a protocol for data communication using, for example, a wireless LAN.

In the present embodiment, an identifier is set for each of the wireless base station 4 as an access point and the surveillance camera 2 as a client. Then, by using these identifiers, a surveillance camera located in the wireless communication range of the wireless base station 4 is detected, a link is automatically set, and a hot spot of the wireless LAN is formed, to enable data communication to be performed.

The connection processing unit 27 is a module for connecting to the wireless base station 4 by means of wireless communication, and transmits an identifier (a phone number, an IP address, and a user ID) for identifying the subject device to the wireless base station 4 to be connected and performs authentication. Note that, in a case where the wireless LAN connection is performed with the wireless base station 4, the connection processing unit 27 may monitor a wireless signal and detect an identifier for identifying the wireless base station 4 in order to form a link for transmitting and receiving data.

Further, the surveillance camera 2 includes a control unit 25 and a memory 24 as application execution modules. The control unit 25 is an arithmetic processing device such as a CPU, and virtually constructs each functional module by executing various programs on the control unit 25. On the control unit 25, an execution processing unit 25c, an execution condition setting unit 25a, and a monitoring state notification unit 25b are constructed as application execution modules.

The execution processing unit 25c is a module that executes an application related to monitoring information management, connects the surveillance camera 2 to the monitoring information management server 3, and causes the surveillance camera 2 and the monitoring information management server 3 to cooperate with each other to implement various functions and services. The application executed by the execution processing unit 25c includes the image monitoring unit 25d. The image monitoring unit 25d is a module that recognizes a change in a person, an action, or an event appearing in the recorded data captured by the surveillance camera 2 and that detects an abnormality appearing in the recorded data. Note that, in the present embodiment, the functions of the image monitoring unit are also provided in the monitoring information management server 3, and depending on the specifications of the surveillance camera 2, all the functions of the image monitoring unit 25d may be executed in the image monitoring unit 314d of the monitoring information management server 3, or the functions may be fulfilled by the image monitoring units 25d and 314d in cooperation.

The application executed by the execution processing unit 25c also includes a UI control unit. The UI control unit is a module that provides a user interface for a web page created in a language such as HTTP through the connection processing unit 27 and the wireless interface 26. Through this web page, execution conditions can be set, and an image or a moving image captured by a camera can be distributed.

The monitoring state notification unit 25b is a module that, in a case where an abnormality such as a sudden change and an excessively loud sound is detected in the captured image in the monitoring range, notifies the monitoring information management server 3, the user terminal, and the like of the situation as a monitoring state notification. As a method of this notification, for example, data may be transmitted to the monitoring information management server 3 in conformity with a predetermined protocol, an electronic mail describing a predetermined character string may be transmitted, or predetermined data may be transmitted and received in conformity with a protocol such as HTTP through a web page provided by the UI control unit. The monitoring information state notification includes an identifier (a phone number and a terminal ID) for identifying the surveillance camera 2 so that the authentication processing can automatically be performed, and the transmitted monitoring information state and the surveillance camera can be associated with each other and accumulated in the monitoring information management server 3.

The execution condition setting unit 25a is a module that sets conditions (execution conditions) related to the execution of the application and restricts the execution of the application by the execution processing unit 25c in each surveillance camera. The conditions set by the execution condition setting unit 25a include a condition for detecting an abnormality.

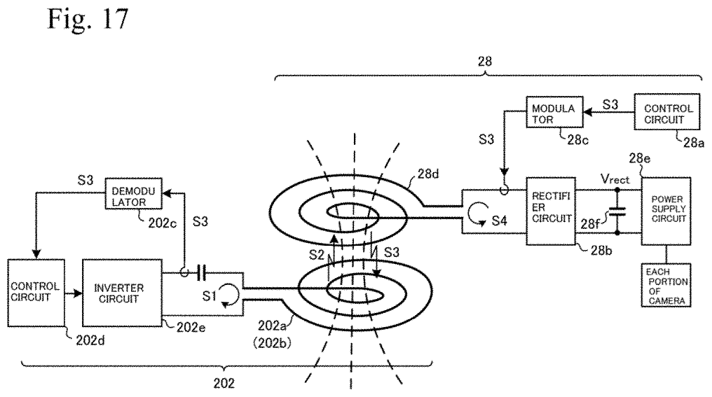

Further, as power supply modules, the camera housing 2L (or 2S) includes a power reception unit 28, and the support base 20 includes a power transmission unit 202, a power supply unit 201, and a communication unit 204. FIG. 17 illustrates internal configurations of the power transmission unit 202 and the power reception unit 28.

As illustrated in the figure, the power transmission unit 202 includes the power transmission coils (primary coils) 202a and 202b, an inverter circuit 202e, a control circuit 202d, and a demodulator 202c. The inverter circuit 202e includes an H bridge circuit (full bridge circuit) or a half bridge circuit, applies a drive signal S1, specifically a pulse signal, to the power transmission coil 202a or 202b, and causes a power signal S2 in the electromagnetic field to be generated in the power transmission coil 202a or 202b due to a drive current flowing through the power transmission coil 202a or 202b. The control circuit 202d comprehensively controls the entire power transmission unit 202, and specifically changes the transmission power by controlling the switching frequency or the switching duty ratio of the inverter circuit 202e.

A predetermined communication protocol is defined between the power transmission unit 202 and the power reception unit 28, and information can be transmitted from the power reception device 30 to the power transmission unit 202 by means of a control signal S3. The control signal S3 is subjected to amplitude modulation (AM) using, for example, backscatter modulation and is transmitted from the power reception coil 28d (secondary coil) to the power transmission coil 202a (202b). The control signal S3 includes, for example, a packet as power control data for controlling the power supply amount to the power reception device 30, data indicating information unique to the power reception device 30, and the like. The demodulator 202c in the power reception unit 28 demodulates the control signal S3 on the basis of the current or voltage of the power transmission coil 202a (202b). The control circuit 202d controls the inverter circuit 202e on the basis of the power control data included in the demodulated control signal S3.

The power supply unit 201 is a module that supplies power to be transmitted in the power transmission unit 202, includes a power storage means such as a rechargeable battery and a battery, and can also receive power supply from the outside through a USB connector 203, an Ac adapter, or the like. Due to the power storage means, drive power can be secured for a certain period of time even in a non-power state caused by a power failure or the like.

The power reception unit 28 includes the power reception coil 28d, a rectifier circuit 23b, a smoothing capacitor 28f, a modulator 28c, a control circuit 28a, and a power supply circuit 28e. The power reception coil 28d receives the power signal S2 from the power transmission coil 202a (202b), and transmits the control signal S3 to the power transmission coil 202a (202b). The rectifier circuit 28b and the smoothing capacitor 28f rectify and smooth a current S4 induced in the power reception coil 32 in response to the power signal S2, and convert the current S4 into direct-current voltage VRECT.

The power supply circuit 28e charges a secondary battery (a battery or a rechargeable battery) of a power supply unit 29 or steps up or down the direct-current voltage Vrect by using the power supplied from the power transmission unit 202, and supplies the power to a controller 42 or another load 40.

The control circuit 28a generates power control data (including a control error packet, a CE packet, and the like) for controlling the power supply amount from the power transmission unit 202 so that the rectified voltage Vrect gets closer to a target value. The modulator 28c modulates the coil current of the power reception coil 28d on the basis of the control signal S3 including the power control data and transmits the control signal S3 to the power transmission coil 202a (202b).

The communication unit 204 is a communication interface for performing data communication, and includes a function of performing non-contact communication by wireless or the like and contact (wired) communication by a cable, an adapter means, or the like. The communication unit 204 transmits status information regarding the support base 20 to a monitoring device management unit 314 of the monitoring information management server 3 by wireless or wire. The status information includes information acquired through the control circuit 202d, such as a remaining battery level of the power supply unit 201 in the support base 20, a power transmission status of the power transmission unit 202 such as power transmission availability and the power transmission amount, a remaining battery level of the power supply unit 29 in the surveillance camera 2, and a power reception status of the power reception unit 28 such as power reception availability and the power reception amount.

(2) Relay Device 6 and Wireless Base Station 4

As illustrated in FIG. 3, the relay device 6 includes, as a communication module, a communication unit 61 that is a communication interface to the communication network NW, a connection management unit 65 that controls connection to the wireless base station 4, and a data conversion unit 63 that performs data conversion between wireless communication with the wireless base station 4 and packet communication with the communication network NW.

The relay device 6 also includes a position information management unit 62 for specifying the current position of the surveillance camera 2, manages a base station identifier for identifying the wireless base station 4 with which the surveillance camera 2 has established communication, specifies a femtocell in which the surveillance camera 2 is located on the basis of the base station identifier, and calculates position information of the surveillance camera 2 by using radio wave intensity to the surveillance camera 2 in the wireless base station 4. The position information obtained on the basis of the base station identifier in this manner is reported to the monitoring information management server 3. Note that the identification of the position information on the basis of the base station identifier can be performed in the surveillance camera 2, and the position information can be reported from the surveillance camera 2 to the monitoring information management server 3.

(3) Monitoring Information Management Server 3

As illustrated in FIG. 5, the monitoring information management server 3 includes as a communication module a communication unit 302, a connection processing unit 301, and the disclosed information distribution unit 303, and includes as a user management module a control unit 310. Also, a storage unit 320 that records various data and a clocking unit 304 that acquires current time are connected to the control unit 310.

The communication unit 302 is a communication device that transmits and receives various data to and from the communication network NW by transmitting and receiving packet data. In the present embodiment, the communication unit 302 has a web server function for distributing a web page on the Internet and an electronic mail receiving function, and can transmit and receive an electronic mail to and from the surveillance camera 2 using a protocol such as HTTP and SMTP, and acquire the monitoring information state notification through the protocol. The connection processing unit 301 is a module that establishes wireless communication between the wireless base station 4 and the surveillance camera 2 located in a predetermined area controlled by the wireless base station 4.

The storage unit 320 is a database that accumulates information regarding the monitoring information management system, and in the present embodiment, includes an installer database 320a that holds information regarding an owner or an installer of a camera, a map DB 320b, and a recorded data accumulation unit 320c that accumulates imaged recorded data and edited recorded data.

The installer database 320a is a storage device that stores personal information such as a name, an address, a mobile phone number, and an e-mail address of an installer in association with an installer identification number that identifies a person who installs (or owns) a camera. In particular, in the present embodiment, the installer database 320a stores access authority related to the terminal device 5 owned by the installer, setting information related to privacy control, and restoration history in association with the installer identification information.

The disclosed information database 320b is a storage device that accumulates information to be distributed to the general terminal 8 of the general viewer Ua through the communication network NW. The disclosed information includes position information regarding a place where the surveillance camera 2 is installed (a latitude, a longitude, and an altitude, an address, a building name, a position in the building, an installation angle, and the like including captured images (still images, moving images, thumbnails, and the like)), such as the map M1 in FIG. 1, and information regarding an installer who has installed the surveillance camera 2 (including a user ID, necessary personal information, access authority, and the like). The disclosed information also includes information for disclosing restoration history information indicating that an owner/installer of the surveillance camera exercises authority to perform processing of releasing blurring of recorded data (restoration processing), for example, installation value information of the surveillance camera, a release level at that time, and information for specifying an accessor who has executed the release of blurring (installer who has exercised the release authority).

The recorded data accumulation unit 320c is a storage device that accumulates an image or a moving image captured by the surveillance camera 2 as recorded data in association with position information where the image has been captured. The recorded data accumulation unit 320c also functions as a recorded data accumulation unit that accumulates an image or a moving image blurred by an edit processing unit 314a as recorded data.

The control unit 310 is an arithmetic module configured by hardware such as a processor such as a CPU and a digital signal processor (DSP), a memory and another electronic circuit, software such as a program having a function thereof, or a combination thereof, and virtually constructs various functional modules by appropriately reading and executing the program, and performs operation control of each unit and various kinds of processing for user operation by means of each of the constructed functional modules. In the present embodiment, the control unit 310 includes an installer registration unit 311, an authentication processing unit 313, a disclosed information management unit 312, and the monitoring device management unit 314. The clocking unit 304 is a module that acquires current time as needed. In the present embodiment, the clocking unit 304 acquires time information such as time of authentication processing executed in the authentication processing unit 313 and execution time of data recording or disclosing processing, and transmits the acquired current time to the control unit 310.

The disclosed information management unit 312 is a module that manages disclosed information accumulated in the disclosed information database 320b and controls the disclosure, and the disclosed information includes restoration history information recorded by a restoration history recording unit 314c. The disclosed information management unit 312 includes an image capturing device information disclosure unit 312a and a release level control unit 312b. The image capturing device information disclosure unit 312a is a module that discloses position information of the surveillance camera 2 specified by the position information acquisition unit 23 through the communication network in association with information specifying an installer (including an owner and an administrator) of the surveillance camera 2.

The release level control unit 312b is a module that controls edit and restoration processing of recorded data performed in the monitoring device management unit 314. The release level control unit 312b also includes AI, and in a case of detecting an abnormality detected by the image monitoring units 25d and 314d, the release level control unit 312b determines whether or not an image thereof needs to be checked in accordance with the incident (case) such as an accident or an incident that has occurred. When the AI of the release level control unit 312b determines that the image needs to be checked, the AI specifies a portion (a person, a face, a body, with whom, time, a place, a thing, how (means), and the like) in the image necessary to specify when, where, who, with whom, and what is being done on the basis of the protocol of the privacy control in accordance with the level at which the blurring processing is released, and determines a release level for visibility. The determination by the release level control unit 312b is input into the monitoring device management unit 314, and the edit processing unit 314a and a restoration processing unit 314b execute edit and restoration processing for the recorded data in accordance with the determined release level.

The monitoring device management unit 314 is a module that manages and controls monitoring devices such as surveillance cameras installed in various places. Specifically, the monitoring device management unit 314 accesses each of the monitoring devices such as the surveillance cameras 2, sets the operating conditions and the like, monitors the operating state, and collects and accumulates from the monitoring device data captured, recorded, and detected by the device. Also, the monitoring device management unit 314 executes edit and restoration processing for the recorded data, and records the edited data and the processing history.

Also, in a case where the monitoring device is of a type in which the surveillance camera 2 is mounted on the support base 20, the monitoring device management unit 314 accesses the support base 20, sets operation conditions and the like thereof, monitors the operating state, and collects and accumulates the detected data. For example, the communication unit 204 of the support base 20 transmits status information regarding the support base 20 to the monitoring device management unit 314 by means of data communication by wireless or wire. The status information includes, for example, a remaining battery level of the power supply unit 201 in the support base 20, a power transmission status of the power transmission unit 202 such as power transmission availability and the power transmission amount, a remaining battery level of the power supply unit 29 in the surveillance camera 2, and a power reception status of the power reception unit 28 such as power reception availability and the power reception amount.

By monitoring the operating state of the support base 20 in this manner, for example, even in a case where a failure has occurred with respect to normal operation, such as power supply being cut off or a remaining battery level being low, or in a case where an abnormality has occurred in the surveillance camera 2, such as a case where the surveillance camera 2 mounted on the support base 20 is detached from the support base 20 or a case where a failure has occurred in power supply, the abnormality can be detected in the monitoring information management server 3, and the observer can be notified of the abnormality through a notification unit 314e. As a result, it is possible to quickly respond to an abnormality such as a failure and theft on the monitoring device side, and to ensure stable maintenance of the monitoring state.

In the present embodiment, the monitoring device management unit 314 includes the edit processing unit 314a, the restoration processing unit 314b, the restoration history recording unit 314c, the image monitoring unit 314d, and the notification unit 314e.

The edit processing unit 314a is a module that makes a subject appearing in an image or a moving image captured by the surveillance camera 2 invisible and blurred. In the present embodiment, the edit processing unit 314a and the restoration processing unit 314b execute edit and restoration processing for the recorded data in accordance with the release level determined by the release level control unit 312b. The restoration processing unit 314b is a module that performs restoration processing of deblurring, in a step-by-step manner, a blurred portion in the recorded data accumulated in the recorded data accumulation unit 320c. The restoration history recording unit 314c is a module that records a history of requesting or executing the restoration processing performed by the restoration processing unit 314b as restoration history information together with information specifying an accessor who has requested or executed the restoration processing.

The image monitoring unit 314d is a module that recognizes a change in a person, an action, or an event appearing in the recorded data captured by the surveillance camera 2 and that detects an abnormality captured in the recorded data. In a case where an abnormality is detected in the image monitoring unit 314d, an alert is transmitted through the notification unit 314e to notify the observer of the abnormality. Note that, in the present embodiment, the functions of the image monitoring unit are also provided in the surveillance camera 2, and depending on the specifications of the surveillance camera 2, all the functions of the image monitoring unit 314d may be executed in the image monitoring unit 25d of the surveillance camera 2, or the functions may be fulfilled by the image monitoring units 25d and 314d in cooperation.

The image monitoring units 25d and 314d are provided with artificial intelligence (AI), can automatically perform recognition processing, and can improve recognition accuracy by means of machine learning such as deep learning. The basic functions of the AI included in the image monitoring units 25d and 314d include a watch function and a security function of detecting an abnormality by continuously performing monitoring and image analysis, a function of performing notification and alert when an abnormality is detected or periodically, a count function of counting persons, articles, and the like, a function of distinguishing between men and women, among standard-sized cars, sub-compact cars, and bicycles, and the like, and a recognition function of recognizing specific individuals, vehicle types, and the like. In addition, other basic functions include a motion sensor function of detecting a specific motion, and a sensor sensitivity function related to temperature, humidity, brightness, and the like.

Further, the AI provided in the image monitoring units 25d and 314d has a statistical analysis function based on the collected big data, and the statistical analysis function includes a function of visualizing and graphing a result of the statistical analysis, a calculation function, a machine learning function using a model obtained as a result of the statistical analysis as training data, and a behavior prediction function and a result prediction function based on the generated model.

The authentication processing unit 313 is a module that acquires device identification information and installer identification information transmitted from the surveillance camera 2 or the terminal device 5 and executes authentication processing on the basis of the identification information. Specifically, the authentication processing unit 313 is a computer that verifies the validity of an accessor or software having the function thereof, acquires the installer identification information through the communication network NW, and compares the information with the installer database 320a to check whether or not the accessor has the right, whether or not the accessor is the person himself/herself, and the like. Then, the authentication processing unit 313 transmits the authentication result information to the disclosed information management unit 312 or the monitoring device management unit 314.

The installer registration unit 311 is a module that accepts user registration for receiving the monitoring information management service provided by the present system and registration of a monitoring device such as a surveillance camera, and records various types of information related to the registration in the installer database 320a. Here, at the time of registering the installer, the installer registration unit 311 registers an ID that is an installer identification number as an identifier for specifying the installer, registers a name, an address, a smartphone/mobile phone number, an e-mail address, and the like as information of the installer, and registers access authority, authentication information, and the like of the installer. In addition, at the time of registering the surveillance camera, the installer registration unit 311 registers an ID that is an installer identification number as an identifier for specifying the installer, registers a name, an address, a smartphone/mobile phone number, an e-mail address, and the like as information of the installer, and registers access authority, authentication information, and the like of the installer.

The disclosed information distribution unit 303 is a module that distributes disclosed information generated by the disclosed information management unit 312 from the communication unit 302 to the general terminal 8 of the general viewer Ua or the like through the communication network NW. Specifically, the disclosed information distribution unit 303 is achieved by a web server function having a content distribution function, and can distribute content that includes material data such as a hypertext markup language (HTML), a picture, a sound, and an image in a document system such as the world wide web (WWW) and that is a web page or the like necessary for connection rate measurement.

(4) Terminal Device 5

The terminal device 5 includes an input interface 51 and an output interface 52 as user interface modules. The input interface 51 is a device for inputting a user operation such as an operation button, a touch panel, and a jog dial.

The output interface 52 is a device that outputs an image or a sound, such as a display and a loudspeaker. In particular, the output interface 52 includes a display unit 52a such as a liquid crystal display, and the image or the sound is displayed on the display unit 22a serving as a graphical user interface (GUI) by an application execution unit 53.

The application execution unit 53 is a module that executes applications such as a general OS, browser software, office software such as word processing software, and image display software, and is usually achieved by a CPU or the like. In the present embodiment, the application execution unit 53 implements a function of executing browser software to connect to the surveillance camera 2 and the monitoring information management server 3, displaying a web page or the like provided by these devices to accept a user operation, and performing data transmission and reception.

The terminal device 5 also includes a communication interface 54. The communication interface 54 is a communication interface for performing data communication, and includes a function of performing non-contact communication by wireless or the like and contact (wired) communication by a cable, an adapter means, or the like. In the present embodiment, the communication interface 54 transmits various requests and authentication information to the monitoring information management server 3 through the communication network NW, and receives data such as a web page from the monitoring information management server 3.

(Monitoring Information Management Method)

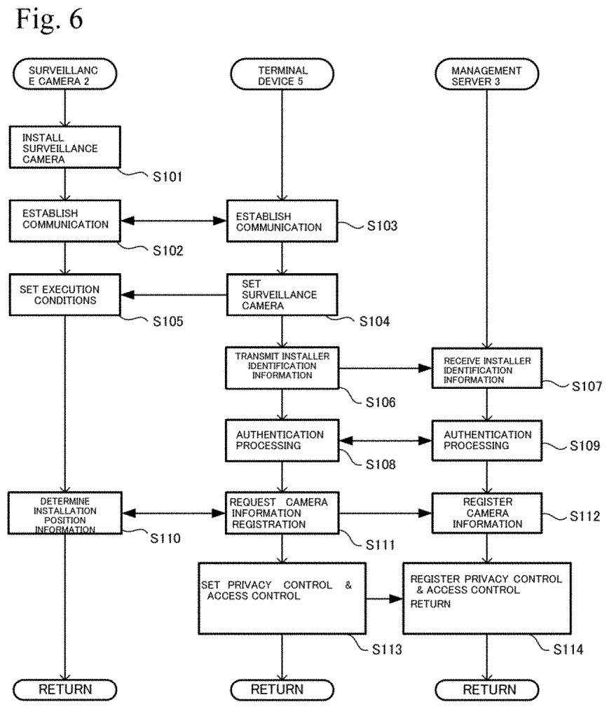

A monitoring information management method can be carried out by operating the monitoring information management system having the above configuration. FIGS. 6 to 9 are flowcharts illustrating the monitoring information management method according to the present embodiment. Note that the processing procedure described below is illustrative only, and each piece of processing may be changed as much as possible. Also, regarding the processing procedure described below, it is possible to appropriately omit, replace, and add steps depending on the embodiment.

(1) Operation when New Surveillance Camera is Installed

First, an operation when a surveillance camera is installed will be described. FIG. 6 is a flowchart illustrating an operation when a surveillance camera is installed in the monitoring information management system according to the present embodiment.

As illustrated in the figure, the surveillance camera 2 that captures an image of a place to be monitored is installed at a predetermined place (S101). After the installation, a communication connection with the terminal device 5 used by the installer Um is established by the connection processing unit 27 (S102 and S103). In this communication establishment, both the new surveillance camera 2 and the terminal device 5 are located in the common Wi-Fi network, and wireless communication is established between these devices. Subsequently, using this established communication, various settings are performed in the surveillance camera 2 from the terminal device 5 (S104 and S105). In this setting, first, information necessary for wireless connection of the surveillance camera 2 with the wireless base station 4, the relay device 6, and the monitoring information management server 3 is set by the execution condition setting unit 25a.

As a result, the surveillance camera 2 is connected to the monitoring information management server 3 through the communication network NW, and information can be distributed to the general terminals 8 dispersedly arranged on the communication network NW through the monitoring information management server 3. Furthermore, the settings by the execution condition setting unit 25a include settings related to monitoring conditions. The monitoring conditions to be set include conditions of moving object detection (a monitoring range, detection sensitivity, and a drive time zone), operations at the time of abnormality detection (settings of e-mail transmission and transfer of a still image and a moving image file), and the like.

Subsequently, the terminal device 5 executes a registration procedure of a new surveillance camera to the monitoring information management server 3. Specifically, the terminal device 5 accesses the installer registration unit 311 provided in the monitoring information management server 3, and transmits owner identification information such as a user ID as an administrator to the monitoring information management server 3 (S106). In the monitoring information management server 3, which has received the owner identification information (S107), authentication processing is performed in the authentication processing unit 313 using the received owner identification information (S108 and S109), and in a case where the authentication is successful, registration processing for the camera information is performed in the installer registration unit 311.

In the camera information registration processing, first, the terminal device 5 acquires installation position information determined in the surveillance camera 2 (S110). Examples of a method of determining the installation position information include a method of acquiring the position information by the surveillance camera 2 itself and a method of using the position information of the surveillance camera 2 detected in the terminal device 5 or the monitoring information management server 3. The position information of the surveillance camera 2 installed in this manner and the user ID of the installer Um who is the owner of the camera are registered in association with each other (S112).

(2) Operation During Monitoring

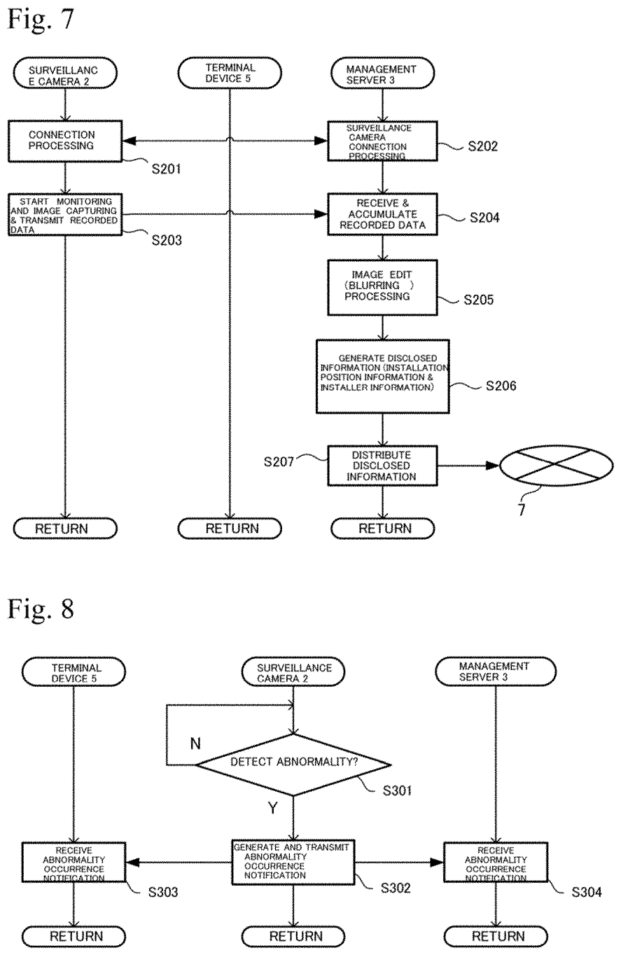

Next, an operation at the time of monitoring using the surveillance camera installed in this manner will be described. FIG. 7 is a flowchart illustrating a monitoring operation of the surveillance camera in the monitoring information management system according to the present embodiment, and FIG. 8 is a flowchart illustrating an operation at the time of abnormality detection performed by the surveillance camera in the monitoring information management system according to the present embodiment.

As illustrated in FIG. 7, when monitoring processing is started, first, connection processing is executed between the surveillance camera 2 and the monitoring information management server 3 (S201 and S202), and after the connection processing is established, the surveillance camera 2 starts monitoring and image capturing. Subsequently, the monitoring state notification unit 25b sequentially transmits recorded data to the monitoring information management server 3, and in the monitoring information management server 3, which has received the recorded data, the monitoring device management unit 314 accumulates the recorded data received by a recorded data collection unit 305 in the recorded data accumulation unit 320c (S203 and S204). For the accumulated recorded data, the edit processing unit 314a of the monitoring information management server 3 executes image edit processing for performing predetermined blurring processing on the recorded data, and the edited recorded data is accumulated in the recorded data accumulation unit 320c (S205).

Also, in the monitoring information management server 3, the disclosed information management unit 312 generates disclosed information (S206). The disclosed information includes installation position information for the surveillance camera, information regarding the installer, a release level of the blurring processing at the present time, and the like. The generated disclosed information is distributed from the disclosed information distribution unit 303 and the communication unit 302 to the general viewer Ua through the communication network NW (S207).

Thereafter, as illustrated in FIG. 8, abnormality detection processing is executed in the image monitoring unit 25d of the surveillance camera 2 or the monitoring device management unit 314 and the image monitoring unit 314d of the monitoring information management server 3. Specifically, in loop processing, normal image capturing processing is continued until an abnormality is detected (“N” in S302). Then, in a case where an abnormality is detected in the drive state of the monitoring device (including the surveillance camera 2 and the support base 20) or in the captured image (“Y” in S301), an abnormality occurrence notification is generated and transmitted from the monitoring state notification unit 25b, the notification unit 314e, or the disclosed information management unit 312 through the monitoring information management server 3, the terminal device 5, or another information terminal to the observer (S302). The abnormality occurrence notification includes the fact that an abnormality has occurred and the type of the abnormality, and the image data or sound data file serving as a basis (or address information such as a URL indicating a storage location of the data file) is attached. The terminal device 5, which has received the abnormality occurrence notification, performs processing for displaying and outputting an alert, and the monitoring information management server 3 accumulates information regarding the generated abnormality and discloses the information as disclosed information from the disclosed information distribution unit 303 through the communication network NW so as to be viewable.

(3) Operation at Time of Information Disclosure

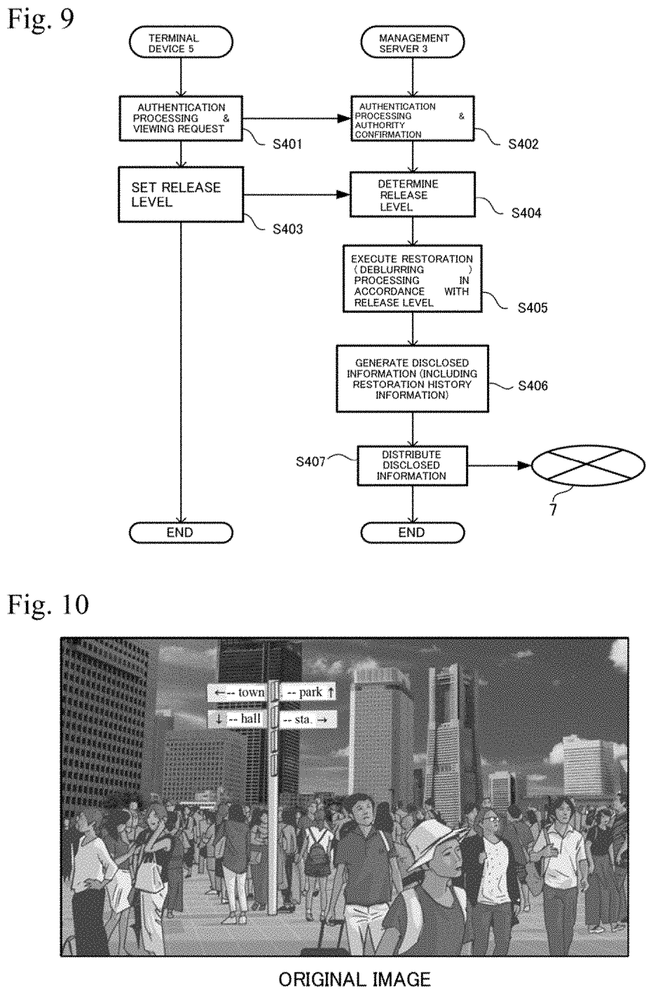

Next, processing for disclosing information captured by the surveillance camera will be described. FIG. 9 is a flowchart illustrating an operation at the time of disclosing information related to the surveillance camera in the monitoring information management system according to the present embodiment. Here, a case where the owner of the surveillance camera views recorded data captured by the camera in which an abnormality is detected will be described as an example.

First, the terminal device 5 accesses the monitoring information management server 3 to perform authentication processing, and a viewing request indicating that viewing is desired is transmitted from the execution processing unit 25c to the monitoring information management server 3 (S401). Subsequently, in a case where the authentication processing is successful, the release level control unit 312b confirms the viewing authority of the accessor who has transmitted the viewing request (S402). In a case where the viewing authority of the accessor is confirmed, the installer Um, who is the authorized accessor, sets a desired release level and transmits the release level to the monitoring information management server 3. The monitoring information management server 3 having received the setting of the release level makes a determination of the release level (S404).

More specifically, for the abnormality detected by the image monitoring units 25d and 314d, the AI included in the release level control unit 312b determines whether or not an image thereof needs to be checked in accordance with the incident (case) such as an accident or an incident that has occurred. When the AI of the release level control unit 312b determines that the image needs to be checked, the AI specifies a portion (a person, a face, a body, with whom, time, a place, a thing, how (means), and the like) in the image necessary to specify when, where, who, with whom, and what is being done on the basis of the protocol of the privacy control in accordance with the level at which the blurring processing is released, and determines a release level for visibility.

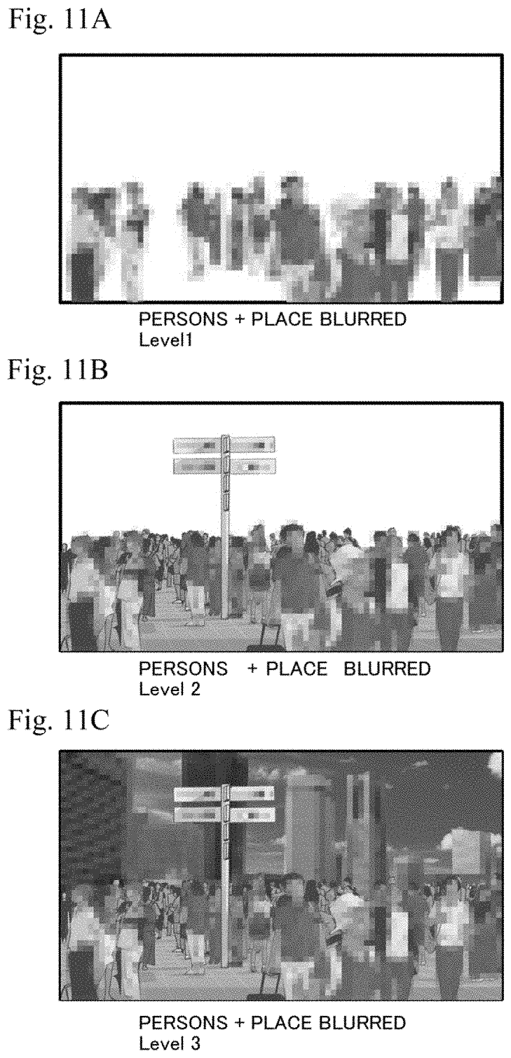

Subsequently, the determination by the release level control unit 312b is input into the monitoring device management unit 314, and the edit processing unit 314a and the restoration processing unit 314b execute deblurring (restoration) processing in accordance with the determined release level (S405). This restoration processing will be described in detail. As for the recorded data accumulated in the monitoring information management server 3, the entire image is clear so that the persons and the place can be specified in the original image before the blurring processing is performed, as illustrated in FIG. 10. For example, as illustrated in FIGS. 11A to 11C, the original image is subjected to processing for blurring the persons in the image and editing processing for removing the buildings, the monument, or the like whose place may be specified so that both the persons and the place cannot be specified. As release levels for blurring the persons and the place, it is possible to set, as illustrated in FIGS. 11A to 11C, a level (FIG. 11A) at which the persons and the place cannot be specified, and only the behaviors of the persons can be visually recognized, a level (FIG. 11B) at which the monument is displayed so that the place can vaguely be specified, and the character information for specifying the place name, the address, and the like is blurred, a level (FIG. 11C) at which the background and the monument are displayed so that the place name can be specified to some extent, and the like.

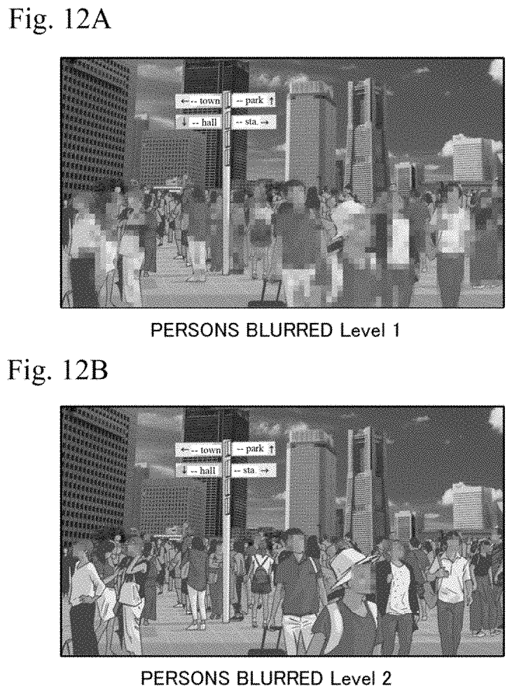

Also, as another method of setting the release levels, a method of making the level of the blurring processing of the persons variable while leaving the place clear is also conceivable. For example, as illustrated in FIGS. 12A and 12B, conceivable levels are a level (FIG. 12A) at which blurring processing such as creating a mosaic is performed on the entire body of each person so that the place can be specified, and so that the flow, the behaviors, and the like of the persons can be confirmed although the faces and the clothes of the persons cannot be specified, and a level (FIG. 12B) at which only the faces of the persons cannot be specified, but the respective detailed behaviors thereof can be visually recognized.

As described above, by enabling blurring of the persons and the place to be released in a step-by-step manner, the monitored image can effectively be used while the privacy of the persons captured is protected as in a case where only the behaviors of the persons can be checked without clarifying the place, in a case where, by clarifying the place and enabling the detailed behaviors of the persons to be visually recognized, the persons do not need to be specified, but the state of an accident or an incident having occurred at the place needs to be checked to some extent, or in another case, which is effective in preventing a crime and solving an incident.

Then, the fact that the owner has exercised the authority to perform processing of deblurring the recorded data in this manner is recorded, and the recorded data is distributed on the communication network NW as disclosed information and is disclosed to an unspecified number of general terminals 8. Specifically, the installation position information for the surveillance camera, the release level at that time, and the restoration history information for specifying the person who has executed the release of the blurring (the installer who has exercised the release authority) are recorded in the disclosed information database 320b, and disclosed information including the restoration history information is generated in the disclosed information management unit 312 (S406), distributed from the disclosed information distribution unit 303 to the communication network NW, and made viewable by the general viewer Ua by means of the general terminal 8 (S407).

(Monitoring Information Management Program)

Note that the monitoring information management system and the monitoring information management method according to the present invention described above can be achieved by executing on a computer a monitoring information management program according to the present invention described in a predetermined language. That is, by installing the program according to the present embodiment in an IC chip or a memory device of a portable terminal device, a smartphone, a wearable terminal, a mobile PC, another information processing terminal, or a general-purpose computer such as a personal computer and a server computer, and executing the program on a CPU, the monitoring information management system having the above-described functions can be constructed, and the monitoring information management method according to the present invention can be implemented.

Specifically, by executing the above-described monitoring information management program according to the present invention on the monitoring information management server 3, the monitoring information management server 3 functions as the position information acquisition unit 23 that specifies the current position of the surveillance camera 2, the image capturing device information disclosure unit 312a that discloses the position information of the surveillance camera 2 through the communication network NW, the recorded data accumulation unit 320c that accumulates the recorded data in association with the position information, and the image monitoring unit 314d that recognizes a change in a person, an action, or an event appearing in the recorded data and that detects an abnormality appearing in the recorded data.

Further, by executing the monitoring information management program, the monitoring information management server 3 functions as the edit processing unit 314a that makes a subject appearing in the recorded data invisible and blurred, the recorded data accumulation unit 320c that accumulates the blurred recorded data, the restoration processing unit 314b that performs the restoration processing of deblurring, in a step-by-step manner, the blurred portion in the recorded data, the restoration history recording unit 314c that records a history of requesting or executing the restoration processing performed by the restoration processing unit 314b as restoration history information together with information specifying an accessor who has requested or executed the restoration processing, and the disclosed information management unit 312 that discloses the restoration history information through the communication network NW.

Note that the monitoring information management program according to the present invention can be distributed through a communication line, for example, and can be transferred as a packaged application that operates on a standalone computer by being recorded on a computer-readable recording medium. Specific examples of the recording medium may include a magnetic recording medium such as a flexible disk and a cassette tape, an optical disk such as a CD-ROM and a DVD-ROM, a RANI card, and various recording media. The computer-readable recording medium in which the program is recorded enables the above-described system and method to be easily implemented using a general-purpose computer or a dedicated computer, and enables the program to be easily stored, transported, and installed.

### Modification Examples

Note that the embodiment described above is an example of the present invention. Therefore, the present invention is not limited to the above-described embodiment, and various modifications can be made according to design and the like without departing from the technical idea according to the present invention.

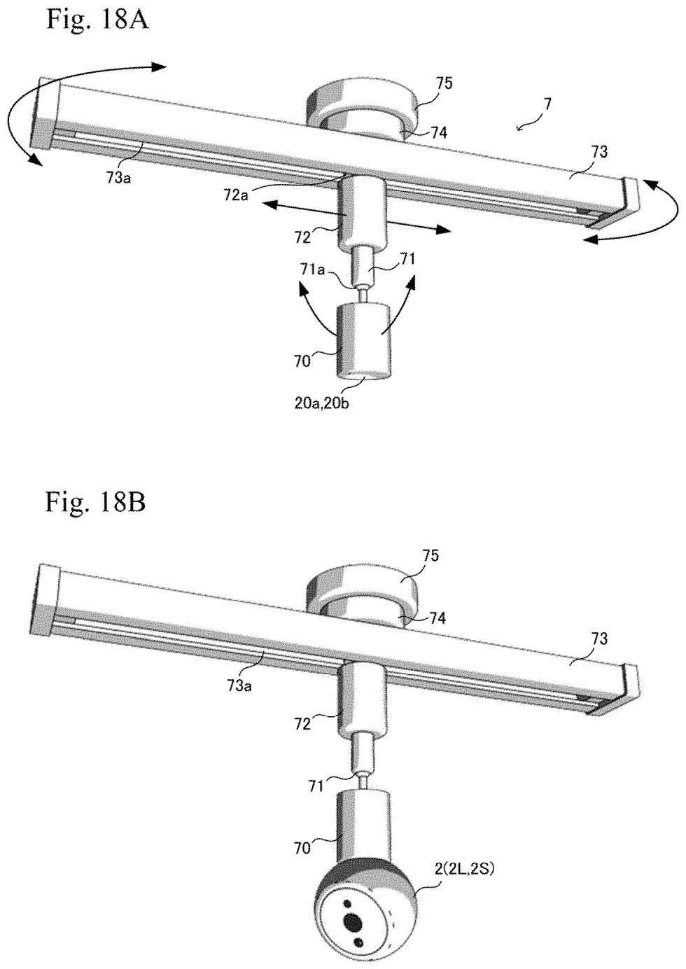

For example, in the above-described embodiment, the camera housing is placed on the upper surface of the support base 20 by using the support base 20 as a stationary type, but may be a hanging type as illustrated in FIGS. 18A and 18B. Specifically, as illustrated in the figure, a suspension means 7 that suspends the camera housing 2L (or 2S) supported via the support surface 20a or 20b is used as the support base 20 described above.

In the present embodiment, the suspension means 7 includes a duct rail 73 suspended from the indoor ceiling surface via a flange portion 74 connected from below to a rosette 75 for power supply provided on the ceiling surface. The duct rail 73 is connected so as to be rotatable about the flange portion 74 in a horizontal plane, and a slit 73a is formed along the longitudinal direction at the center of the lower surface of the duct rail 73. A cylindrical hanging ceiling portion 72 is slidably suspended from the slit 73a via a sliding outlet 72a.

Inside the slit 73a, a power supply rail electrically connected from the rosette 75 for power supply is laid along the longitudinal direction of the duct rail 73, while the support base 70 is suspended below the hanging ceiling portion 72 via a universal joint 71, and electricity is supplied from the power supply rail of the slit 73a to the power transmission unit 202 of the support base 70 through the sliding outlet 72a.

As described above, the coils 202a and 202b are disposed and the magnet 204 is provided inside the support surface 20a (20b), which is the lower surface of the support surface 80, and the camera housing 2L (or 2S) is attracted to the support surface 20a (20b) by the magnet 204, whereby non-contact power supply can be performed.

(Operation and Effect)

According to the present embodiment, by enabling blurring of the persons and the place to be released in a step-by-step manner, the monitored image can effectively be used while the privacy of the persons captured is protected as in a case where only the behaviors of the persons can be checked without clarifying the place, in a case where, by clarifying the place and enabling the detailed behaviors of the persons to be visually recognized, the persons do not need to be specified, but the state of an accident or an incident having occurred at the place needs to be checked to some extent, or in another case, which is effective in preventing a crime and solving an incident.

On the other hand, in a case where the installer or the like exercises the authority to perform deblurring processing on the blurred recorded data, information about the person who has executed the deblurring processing is disclosed to an unspecified large number of the general terminals 8 through the communication network NW. Thus, the general public can constantly check through the communication network that the privacy in the image captured by the surveillance camera is not violated, and it is possible to prevent the installer of the camera from viewing the monitored image for the purpose of abuse.

Note that the present invention is not limited to the above-described embodiment as it is, and the components can be modified and embodied without departing from the gist thereof at the time of carrying out the invention. Also, various inventions can be formed by appropriately combining the plurality of components disclosed in the above embodiment. For example, some components may be deleted from all the components shown in the embodiment.

### EXPLANATION OF SYMBOLS

Ua General viewer
Um Installer (Observer)
2 Surveillance camera
3 Monitoring information management server
4 Wireless base station
5 Terminal device
6 Relay device
7 Communication network
8 General terminal
9 Communication satellite
20 Support base
21 Input interface
21a CCD camera
21b Sound microphone
22 Output interface
22a Display unit
23 Position information acquisition unit
24 Memory
25 Control unit
25a Execution condition setting unit
25b Monitoring state notification unit
25c Execution processing unit
25d Image monitoring unit
26 Wireless interface
27 Connection processing unit
28 Power reception unit
29 Power supply unit
51 Input interface
52 Output interface
52a Display unit
53 Application execution unit
54 Communication interface
61 Communication unit
62 Position information management unit
63 Data conversion unit
65 Connection management unit
201 Power supply unit
202 Power transmission unit
203 Connector
204 Communication unit
301 Connection processing unit
302 Communication unit
303 Disclosed information distribution unit
304 Clocking unit
310 Control unit
311 Installer registration unit
312 Disclosed information management unit
312a Image capturing device information disclosure unit
312b Release level control unit
313 Authentication processing unit
314 Monitoring device management unit
314a Edit processing unit
314b Restoration processing unit
314c Restoration history recording unit
314d Image monitoring unit
314e Notification unit
320 Storage unit
320a Installer database
320b Disclosed information database
320c Recorded data accumulation unit

1. A monitoring information management system that performs monitoring by means of an image capturing device that captures an image or a moving image, the monitoring information management system comprising:
a position information acquisition unit that specifies a current position of the image capturing device;
an image capturing device information disclosure unit that discloses position information of the image capturing device specified by the position information acquisition unit through a communication network;
an image accumulation unit that accumulates an image or a moving image captured by the image capturing device as recorded data in association with the position information; and
an image monitoring unit that recognizes a change in a person, an action, or an event appearing in the recorded data captured by the image capturing device and that detects an abnormality appearing in the recorded data.

2. The monitoring information management system according to claim 1, comprising:
an edit processing unit that makes a subject appearing in an image or a moving image captured by the image capturing device invisible and blurred;
a recorded data accumulation unit that accumulates the image or the moving image blurred by the edit processing unit as recorded data;
a restoration processing unit that performs restoration processing of deblurring, in a step-by-step manner, a blurred portion in the recorded data accumulated in the recorded data accumulation unit;
a restoration history recording unit that records a history of requesting or executing the restoration processing performed by the restoration processing unit as restoration history information together with information specifying an accessor who has requested or executed the restoration processing; and
a restoration history information disclosure unit that discloses the restoration history information recorded by the restoration history recording unit through the communication network.

3. A monitoring information management program that performs monitoring by means of an image capturing device that captures an image or a moving image, the monitoring information management program causing an information processing terminal to function as:
a position information acquisition unit that specifies a current position of the image capturing device;
an image capturing device information disclosure unit that discloses position information of the image capturing device specified by the position information acquisition unit through a communication network;
an image accumulation unit that accumulates an image or a moving image captured by the image capturing device as recorded data in association with the position information; and
an image monitoring unit that recognizes a change in a person, an action, or an event appearing in the recorded data captured by the image capturing device and that detects an abnormality appearing in the recorded data.

4. The monitoring information management program according to claim 3, causing the information processing terminal to further function as:
an edit processing unit that makes a subject appearing in an image or a moving image captured by the image capturing device invisible and blurred;
a recorded data accumulation unit that accumulates the image or the moving image blurred by the edit processing unit as recorded data;
a restoration processing unit that performs restoration processing of deblurring, in a step-by-step manner, a blurred portion in the recorded data accumulated in the recorded data accumulation unit;
a restoration history recording unit that records a history of requesting or executing the restoration processing performed by the restoration processing unit as restoration history information together with information specifying an accessor who has requested or executed the restoration processing; and
a restoration history information disclosure unit that discloses the restoration history information recorded by the restoration history recording unit through the communication network.

5. A monitoring information management method that performs monitoring by means of an image capturing device that captures an image or a moving image, the monitoring information management method comprising:
an image capturing device information disclosure step of specifying, by means of a position information acquisition unit, a current position of the image capturing device, and disclosing, by means of an image capturing device information disclosure unit, position information of the image capturing device specified by the position information acquisition unit through a communication network; and
an image monitoring step of accumulating an image or a moving image captured by the image capturing device in an image accumulation unit as recorded data in association with the position information, and recognizing, by means of an image monitoring unit, a change in a person, an action, or an event appearing in the recorded data captured by the image capturing device and detecting an abnormality appearing in the recorded data.

6. The monitoring information management method according to claim 5, comprising:
an edit processing unit that makes a subject appearing in an image or a moving image captured by the image capturing device invisible and blurred;
a recorded data accumulation unit that accumulates the image or the moving image blurred by the edit processing unit as recorded data;
a restoration processing unit that performs restoration processing of deblurring, in a step-by-step manner, a blurred portion in the recorded data accumulated in the recorded data accumulation unit;
a restoration history recording unit that records a history of requesting or executing the restoration processing performed by the restoration processing unit as restoration history information together with information specifying an accessor who has requested or executed the restoration processing; and
a restoration history information disclosure unit that discloses the restoration history information recorded by the restoration history recording unit through the communication network.

7. An image capturing device that includes a function of transmitting a captured image through a communication means, the image capturing device comprising:
a camera housing that has a spherical portion at least on a bottom surface thereof;
a support base that has a support surface including a spherical surface having a curvature matching that of the spherical portion of the bottom surface of the camera housing and that detachably supports the camera housing via the support surface;
a power reception coil that is disposed so as to face the spherical portion inside the camera housing; and
a power transmission coil that is disposed so as to face the support surface inside the support base and that can charge the power reception coil in a non-contact manner.

8. The image capturing device according to claim 7, further comprising attracting means that are provided respectively on the spherical portion side of the bottom surface of the camera housing and on the support surface side of the support base and that attract each other by means of magnetic forces.

9. The image capturing device according to claim 7, wherein the support base further includes:
a power supply means that supplies power to the power transmission coil; and
a suspension means that suspends the camera housing supported via the support surface.

10. The monitoring information management system according to claim 1, comprising the image capturing device according to claim 7 as the image capturing device that performs monitoring.

11. The monitoring information management program according to claim 3, comprising the image capturing device according to claim 7 as the image capturing device that performs monitoring.

12. The monitoring information management method according to claim 5, comprising the image capturing device according to claim 7 as the image capturing device that performs monitoring.
